(19) United States
(12) Patent Application Publication
(10) Pub. No.: US 2024/0014659 A1
(43) Pub. Date: Jan. 11, 2024

(54) PHOTOVOLTAIC SOURCED POWER STATION WITH INTEGRATED BATTERY CHARGE/DISCHARGE CYCLE

(71) Applicant: Paladin Power Inc., Carlsbad, CA (US)

(72) Inventors: Klaus P. Wuellner, San Jose, CA (US); Ted Thomas, Murrieta, CA (US)

(21) Appl. No.: 18/371,896

(22) Filed: Sep. 22, 2023

Related U.S. Application Data
(63) Continuation-in-part of application No. 16/095,496, filed on Oct. 22, 2018.
(60) Provisional application No. 63/409,499, filed on Sep. 23, 2022.
(60) Provisional application No. 62/325,167, filed on Apr. 20, 2016.

(51) Int. Cl. H02J 3/32; H02J 7/35; H02J 3/40; H02J 7/00

(52) U.S. Cl. CPC H02J 3/32; H02J 7/35; H02J 3/40; H02J 7/0048

(57) ABSTRACT

An integrated power control system for transferring electric power from a photovoltaic source through a power module to a transfer switch and/or a storage battery. A monitoring system includes external current sensors that control connection of the transfer switch to the utility distribution network. Electrical energy that is generated by the photovoltaic source is directed to a load and a lithium-ion storage battery according to the level of photovoltaic power generated, the load demand, and the charge level of the storage battery. At times when the photovoltaic energy is greater than the load demand and the charge level of the battery is at full capacity, excess energy is directed to the electrical distribution grid. In case of grid outage, energy may be drawn from the battery to maintain electric supply for designated loads.

### CROSS REFERENCE TO RELATED APPLICATIONS

The present application is a continuation-in-part of pending U.S. Provisional Patent Application No. 63/409,499 filed Sep. 23, 2022 which is hereby incorporated by reference in its entirety pending; and of U.S. patent application Ser. No. 16/095,496, filed Oct. 22, 2018, which is a 35 U.S.C. § 371 of International Application No. PCT/US2017/028533, filed on Apr. 20, 2017, which claims priority to U.S. Provisional Application No. 62/325,167 filed Apr. 20, 2016, which is hereby incorporated by reference in its entirety.

### BACKGROUND OF THE INVENTION

### Field of Invention

The presently disclosed invention relates to photovoltaic power stations (“PV power stations”) and, more particularly, PV power stations with capability for storing electrical energy, regulating electrical energy that is supplied to a load, and supplying electrical energy to the distribution grid.

### Background of the Prior Art

Electrical systems for converting solar radiation to electrical energy are known in the art. Essentially, such systems comprise an array of multiple photovoltaic (“PV”) cells or panels that are electrically connected together to provide electrical power when the cells or panels are illuminated by solar energy. Often, the electrical energy that is generated from the solar panels is stored in a battery or may be transmitted to the electrical power distribution grid through an inverter.

In the prior art, PV power generating systems have had several inherent shortcomings and disadvantages. For example, the generated power is limited, in part, in proportion to the intensity of the solar radiation and by the efficiency of the PV module design. Often, PV power stations are not sized to generate sufficient power to directly serve the intended load, such as a household, in real-time and during times of peak demand. Moreover, such systems provide power only at times when the solar panel array is illuminated by solar radiation. Thus, no electrical power is available from PV systems at night and only limited power is available during times when sunlight intensity is relatively low.

To overcome these difficulties, PV electrical systems are generally connected to an electrical distribution grid of an electric utility. In that way, the electrical power generated by the PV system can be augmented by electrical power drawn from the distribution grid. At times when electrical power that is generated by the PV array exceeds the electrical power demand of the load, the excess power is stored in a storage battery for future consumption or fed to the distribution grid.

It was seen that prior PV power systems could be more efficient if they were capable of storing energy at times when the generated power exceeded the demand and if they could draw on the distribution grid at times when generated power in combination with delivery of stored power was insufficient to meet the demand. Efficiencies could be improved by limiting transmission of electrical power. In addition, reliability could be improved by augmenting the real-time power generated by the PV modules with energy that was automatically, locally stored so as to modify the effect of variability of solar illumination and differences in power demand by the load.

It was also seen that a PV power station would be advantageous if it could reduce the user's reliance on the power distribution grid. The cost of electrical power delivered over the grid has been seen to rise over time. Also, due to the monopolistic nature of electrical generation and distribution by utilities, a consumer has limited ability to negotiate for more favorable usage rates. Also, it has been observed that the heavy utilization and age of the distribution grid give cause for concern. The components of the distribution grid are stressed and have tended to fail, especially during periods of peak delivery when they are most needed. This leaves the consumer wholly dependent on a distribution grid that may be prone to service interruptions or potential safety hazards.

For all of the forgoing reasons, mechanisms that reduce the dependence on commercial electrical distribution grids have been increasingly seen as economically and practically advantageous.

### SUMMARY OF THE INVENTION

The presently disclosed power station operates in a mains-interactive mode while connected to an active distribution grid. The power station operates in stand-alone mode in which it is disconnected from the electrical distribution grid when the distribution grid is out of service. The disclosed power station includes a power module that has at least one inverter that produces instantaneous alternating current power (“AC power”) in response to photovoltaic-generated power.

At times when the power station is connected to an active distribution grid, the disclosed power station uses instantaneous AC power from the inverter to satisfy, in whole or in part, power demand from a load. When the instantaneous AC power from the inverter is greater than the power demand of the load, excess AC power is converted to DC power and stored in a battery until the battery is at storage capacity. When the battery is at storage capacity, excess AC power is sent to the distribution grid. If the inverter in the power module is producing instantaneous AC power that is less than the power demand of the load and the battery charge remains above a threshold level, the power shortfall is drawn from the battery so that the instantaneous power from the inverter matches the power demand of the load. When the battery charge is less than the threshold level but still greater than a minimum level, instantaneous power from the inverter is used to off-set power demand from the load, but any shortfall of the power demand of the load is drawn from the distribution network, not the battery. If the charge level of the battery falls below a minimum level, all AC power from the inverter is converted to DC power and stored in the battery until the battery charge level is above the minimum level. Based on this hierarchy of charge levels of the battery, the instantaneous power from the inverter relative to the power demand of the load establishes a priority for charging and discharging the battery and maintaining electric power production from the power station.

At times when the distribution grid associated with the power station is out-of-service, the power station automatically disconnects from the grid and operates in stand-alone mode on power that is either generated from a photovoltaic source or drawn from the battery. In this mode, instantaneous AC power from the inverter is used first to satisfy or partially-satisfy the power demand of the load. If the instantaneous AC power is less than the power demand of the load, additional electrical power is drawn from the battery to the extent it is available.

It has been found that the mains-interactive mode and the stand-alone mode provide a power station that simplifies the use of photovoltaic generated power and improves the reliability of photovoltaic power sources irrespective of simultaneous solar illumination while also significantly reducing grid load.

In either the mains-interactive mode or the stand-alone mode, limits on the charge level of the battery may be set to preserve battery life and to maximize efficiency. In either mode, photovoltaic-generated power and/or stored battery power is converted from DC power to AC power through at least one inverter in at least one power module. Electrical current that would flow from the grid to connected loads (such as electrical appliances) absent the at least one inverter is instantaneously offset (brought to zero) by the instantaneous electrical power that is fed from the inverter to the grid connection node. In this way, the disclosed power station reduces grid burden and increases the overall efficiency of the photovoltaic installation by reducing grid losses and other losses arising out of the transmission and storage of electric power.

Preferably, components of the disclosed system and method are located in a single electrical enclosure. The integration of the method and system herein described into a single physical unit are unknown in the prior art.

### BRIEF DESCRIPTION OF THE DRAWINGS

FIG. 1 is a system layout of the disclosed power station;

FIG. 2 is a schematic drawing of the power module that is included in the disclosed power station; and

FIG. 3 is an illustration of the physical arrangement of the elements of a preferred embodiment of the disclosed power station.

Other embodiments and features of the presently disclosed invention will become apparent to those skilled in the art as a description of a presently preferred embodiment proceeds.

### DESCRIPTION OF A PRESENTLY PREFERRED EMBODIMENT

In a preferred embodiment of the presently disclosed invention, a power station optimizes use of electric power produced from a photovoltaic source such as an array of photovoltaic solar panels to devices that consume electric power such as electric household appliances. Such devices are generally referred to herein as “electric loads” or sometimes merely “loads.” While residential loads are depicted in the example of the preferred embodiment, the disclosed power station is also useful with commercial and/or industrial loads.

Due to the diurnal nature of solar power, the power station operates in conjunction with an electrical power distribution grid of the type that is supported by electric utilities throughout the country. The disclosed power station has several operating modes. The power distribution grid has a generally high degree of reliability so that, in most cases, the power station operates in a “mains-interactive” mode wherein the power station is electrically coupled to the electric distribution grid at times when the grid is serviceable. However, the disclosed power station also provides for instances when the power distribution grid is out of service when the power station decouples from the distribution grid to operate in “stand-alone” mode.

While in the mains-interactive mode, at least one inverter in at least one power module converts DC power from the photovoltaic source to instantaneous AC power. The instantaneous AC power from the inverter is synchronized with AC power on the power distribution network and provided to the terminals that connect the power station to the distribution grid to instantaneously balance against electric power demands of the load. When the instantaneous power generated by the inverter is greater than the power demand of the load, the excess power may be converted to DC power and delivered to a battery for storage. The power station balances instantaneous power from the inverter(s) against power demands of the load in real-time so that the disclosed power station affords improved efficiency by limiting the transmission and storage of electrical energy.

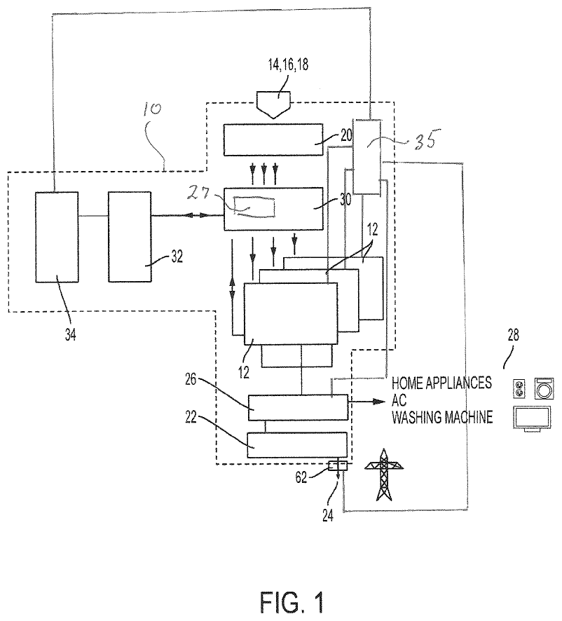

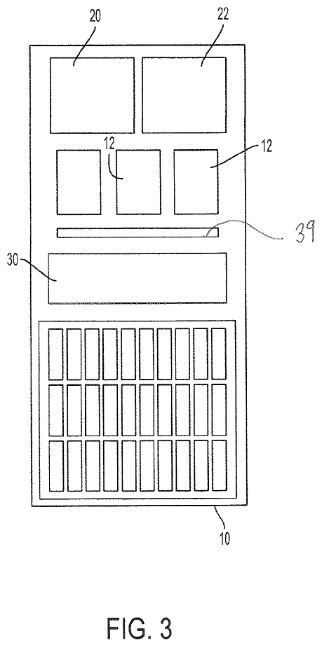

A presently preferred embodiment of the disclosed power station is shown and described in connection with FIGS. 1-3. Referring particularly to FIGS. 1 and 3, the disclosed power station is an integrated device that is housed in an enclosure 10. Enclosure 10 may include up to three or more power modules 12 that may be connected in electrical parallel to accommodate respective photovoltaic sources such as linear arrays of solar panels 14, 16 and 18.

In some embodiments, each power module 12 may be associated with two or more photovoltaic (“PV”) streams. That is, each power module 12 may be connected in a linear array or “string” of PV devices. The strings of PV devices are connected to power module 12 in electrical parallel so that each string provides an independent electrical power stream to the power module 12. In this way, the strings may afford more consistent electrical power that is less subject to the vicissitudes of power conversion of PV devices.

Power modules 12 are scalable and may be connected in parallel to increase the total output power of the power station as appropriate to the economies of the particular application. Each power module 12 may include monitoring software and/or firmware that is directed to synchronous operation of two or more power modules that are connected in electrical parallel. Enclosure 10 may include cabinet fixtures, connectors and wiring to accommodate power modules 12 so that the power modules may be inserted in the enclosure in a plug-in fashion as appropriate for the power requirements of a particular application.

FIGS. 1 and 3 further depict disconnect switches 20 and 22 for controlled connection to the photovoltaic (“PV”) source (switch 20) and to the utility distribution network (switch 22). A load transfer switch 26 that is electrically connected to power modules 12 also includes terminals such that power modules 12 may be selectively connected to an electrical load 28 or a utility distribution network 24 through disconnect switch 22. Transfer switch 26 may be a power contactor that has a multifunctional contact set. In addition, a ground fault detector-interrupter (GFDI) 27 is interposed between power modules 12 and a storage battery 32 and also between power modules 12 and solar panel arrays 14-18.

Preferably, battery 32 is a lithium-ion-phosphate battery. As hereafter more fully explained, battery 32 stores or delivers the difference in energy between instantaneous power that is produced by the inverters of power modules 12 and the electric power demand of the load (“the Demand”). In addition, battery 32 may provide an energy source or accept energy storage during stand-alone operation of the power station.

FIGS. 1 and 3 also show a battery monitoring system 34. During cyclic discharging and recharging of battery 32, battery monitoring system 34 increases battery life and improves battery safety by controlling charging and discharge voltages. Battery monitoring system 34 also monitors the state of charge of battery 32, the single cell temperature of battery 32, and the battery disconnection contactor 30. In embodiments, battery monitoring system 34 may be included in a battery enclosure that is separate from enclosure 10.

A programmable controller 35 cooperates with operational software to cause the inverters of power modules 12 to synchronously balance instantaneous power demand from the load. Such software monitors external current sensors to control the inverter feed-in current to the distribution grid to power demand of the load. Programmable controller 35 also controls power back-up as later described herein.

Energy flow in the power station is controlled according to instantaneous AC power produced by the inverters of power modules 12 and real-time metering by a grid sensor 62. The system control unit 35 cooperates with grid sensor 62 to monitor and control power modules 12 and also to monitor and control the battery charge/discharge process. Programmable controller 35 and power modules 12 also afford remote grid voltage sensing and grid current sensing and provide control of power flow and backup operation in the event of grid outage.

The disclosed power station includes a user interface 39 that may be located on the exterior of enclosure 10. User interface 39 is electrically connected to controller 35 to enable selective user control of current, time, demand management, load shifting, power consumption, net metering and other features and variables of the power station.

Programmable controller 35 of the presently preferred embodiment may also enable status monitoring directly and via remote data link for online monitoring, phone applications, remote troubleshooting, and software and/or firmware updates.

The power station further includes a control circuit such as controlled area network bus controller 37 (“a CAN-bus controller”) of the known type used as communication field bus. CAN-bus controller 37 affords remote monitoring and control of the power station through a designated controlled area network (“CAN”) master module and ethernet/internet communication such as through a smartphone. The CAN-bus controller is connected to battery monitoring system 34 to support monitoring battery conditions that are acquired by the battery monitoring system.

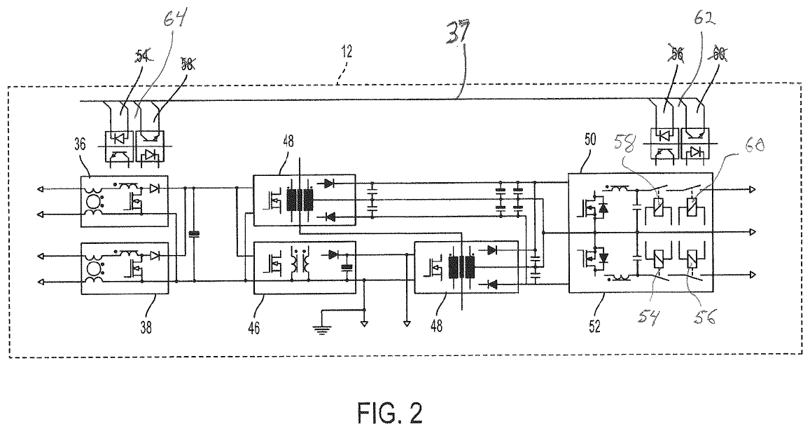

FIG. 2 is a functional diagram of the details of power modules 12. Each power module 12 receives input power from at least one respective solar panel array 14-18. Each power module 12 includes circuitry for two maximum power point tracking circuits (“MPPT circuits”) 36 and 38 that correspond to respective independent photovoltaic string inputs. In embodiments, each power module 12 may include circuitry for three or even more independent photovoltaic inputs or MPPT circuits. In the example of the preferred embodiment, MPPT circuits 36, 38 are synchronized to work on one common DC link (#1) with a nominal voltage of 470 VDC and a maximum voltage, related to the maximum input voltage, of 500 VDC. In embodiments, power module 12 may produce 5 KW to 7 KW per module with up to six synchronized modules producing up to 42 KW of power depending on the production of each module and the number of modules.

MPPTs 36 and 38 are electronic DC to DC converters that optimize the match between the solar arrays 14-18, battery 32, and utility distribution network or grid 24. Such matching maximizes the energy available from solar panel arrays 14-18 throughout operation of the power station. The voltage at which solar panel arrays 14-18 produce maximum power is sometimes referred to as “the maximum power point” or “the peak power voltage.”

Each power module 12 further includes a battery charge controller 46 for lithium-ion-phosphate battery 32. In the example of the preferred embodiment, battery 32 may have a rated voltage of 96V. DC link (#1) supplies battery charge controller 46 and isolating DC-DC converters 48.

Each power module 12 also includes high-frequency inverters 50, 52 that convert the variable direct current (DC) output of the solar panel arrays 14-18 to alternating current (AC) that is synchronized to and compatible with the frequency on the distribution grid. In this way, the output of the inverters is suitable to feed to a commercial electrical grid or to a local, off-grid electrical network that supplies designated loads. DC-DC converter 48 supplies high-frequency inverter stages 50, 52 for phase 1 and 2 with DC link (#2). In an example, DC link (#2) may have a nominal voltage of +/−200 VDC with the maximum voltage on DC link #2 electronically limited to +/−240 VDC. Preferably, inverters 50, 52 include output overcurrent protection that has internal electronic current limiting and 2-pole magnetic circuit breakers 54, 56 and 58, 60 in each inverter output circuit.

Controller 35 causes inverters 50, 52 to synchronize the solar power to the load frequency and the power demands. Inverters 50,52 synchronize the input power from the PV source to match the instantaneous load demand.

At times when battery 32 is not fully charged, power from the inverters that is not required to match the instantaneous load demand (“excess power”) is delivered to battery 32 through a high-frequency bridge-type rectifier that converts power form inverters 50, 52 to DC power. At times when battery 32 is fully charged, excess power is routed to the distribution grid. Thus, inverters 50, 52 operate to produce AC power to the load and/or distribution network and produce DC power to battery 32. Preferably, inverters 50, 52 are designed for plug-in compatibility with enclosure 10.

In each power module 12, both high-frequency inverter stages 50, 52 are simultaneously disconnected from the main connections through four independently controlled relays 54-60. Relays 54-60 ensure disconnection from grid 24 to provide “anti-islanding” or in the event of inverter failure. “Anti-islanding” refers to the capability of an inverter to sense a power outage on the distribution network 24 and shut itself down to stop the production of electricity.

Each power module 12 has two independent isolated CAN nodes, one on the dual MPPT unit 36, 38 and one on the hybrid inverter 50, 52. This ensures monitoring and control of both the MPPT units 36, 38 and the hybrid inverters 50, 52 through the CAN-bus controller.

Operation of the power station is first explained with respect to conditions wherein the power station is connected to an active utility distribution network that maintains electric voltage on the network. Under such operating conditions, the utility disconnect switch 22 is closed and the load transfer switch is also closed to provide an electrical connection between the power modules 12 and the utility distribution network 24 and between the power modules 12 and the load 28 through the load terminal of the load transfer switch 26. Under these conditions, if solar energy illuminates the solar panel arrays 14-18, DC power is conducted to the power modules 12 where the DC power is converted to AC power. AC power is then passed through the load transfer switch 26 to balance the power demand of the load 28 in real time. When battery 32 has a given charge level (which may be more than 50% of the nominal capacity), the power modules feed exactly the amount of energy into the grid to compensate the instantaneous power demand of load 28.

At times when the power generated by the power modules 12 exceeds the power demand of load 28, the battery monitoring system 34 monitors the charge level of battery 32 to send the excess energy either to the battery 32 or to the utility distribution network 24. If the charge level of the battery is at the maximum level, the excess energy is sent to the distribution network 24. Otherwise, the charge level of the battery is below the maximum level for the battery and the excess energy is sent to battery 32 and stored.

At times when the power generated by MPPT's 36 and 38 in power modules 12 is less than the power demand of load 28, the power source that is called on to satisfy the difference in power again is subject to the charge level of the battery. If the charge level of the battery is above a threshold level, then the needed additional power is drawn from battery 32. The threshold level is a predetermined level that is based, in part, on the service factor for the battery. For example, the threshold level may be selected such that the battery is not discharged to a very low level because such use would impair the useful life of the battery. It has been found that degradation of the effective battery capacity depends mainly on the number of charge/discharge cycles in combination with the depth of discharge. To extend battery life, the discharge process can be limited to 70% of a given depth of discharge. Also, consideration is given to reasonable amounts of energy that should be maintained in the battery in the event of emergency conditions. A typical charge level for the threshold level may be 60% of the fully-rated charge.

If the charge level of the battery is below the threshold level, but still greater than a minimum charge level, then the needed power is drawn from the distribution network 24. The minimum charge level is determined according to the need for an energy reserve in the event of an outage of the utility distribution network 24—either during the day when the solar panel array 14-18 is capable of generating power or at night when no power from solar panel array 14-18 will be available. A typical level of the minimum charge may be 20% of the fully rated charge.

At times when the charge level of the battery is less than the minimum level, all energy generated by the solar panel array 14-18 is sent to battery 32 for storage and the load is powered from the utility distribution network 24 without real-time balancing of the power demand from power modules 12.

The above-described hierarchy for power distribution can be made subject to certain exceptions at the discretion of the user. For example, if the power demand by the load during load peaks is greater than the power generated from the inverters, then the additional needed power may be drawn from the battery. This rule enables the power station to cut all power peaks using stored battery power.

It can be seen that the above-described hierarchy for cycling power to and from the battery can be related to typical circumstances for a residential user during a 24-hour period. For example, during late morning and early afternoon, residential power demand tends to be lower and, assuming full solar illumination, PV production from solar panel array 14-18 will tend to be at its greatest. At those times, the power station charges battery 32 while the power station is self-sufficient to satisfy power to the load from the power modules 12. If battery 32 becomes 100% charged, power is sent to the electrical distribution grid.

In the late afternoon and early evening, circumstances for a typical residential user have likely changed. At those times, the solar power produced tends to have decreased while the demand from the load tends to have increased so that the power generated by MPPT's 36 and 38 of the power modules 12 is less than the power demand of the load 28. During this phase, while the charge level of battery 32 remains above the threshold level, the shortfall of energy from the power modules 12 that is needed to balance the energy drawn by load 28 is drawn from battery 32.

In the evening when there is no solar illumination, MPPT's 36 and 38 of power modules 12 produce no power. However, the power station continues to operate with the inverters 50, 52 in the utility-interactive mode so that the power station draws power from battery 32 until the charge level of the battery falls to the predetermined minimum level (e.g. 15-20% of rated capacity). After that, the energy needed to supply the load demand is drawn from the utility distribution network. Stopping the draw of power from battery 32 at the minimum charge level retains a residual level of power in battery 32 for emergency use in case the distribution network fails during the night.

The above explanation of the power station assumes that the utility distribution network 24 remains active with electrical power available from that network. During periods of utility failure, the power station works in emergency power mode. The inverters 50, 52 of power module 12 operate in stand-alone mode to provide electrical power to selected loads. The emergency power mode starts automatically if power on the grid fails for more than a given time period—e.g. 10 seconds. In that case, all of the electrical circuits that are connected to emergency power are powered independent of the utility. The time that emergency power is available depends on the charge level of the battery at the inception of the emergency power condition, the energy demand during the period of emergency power, and the available PV energy during the period of emergency power.

In the event that utility distribution network 24 fails, transfer switch 26 automatically disconnects load 28 from the distribution grid 24. The power station has an emergency power circuit that is connected to the mains when utility power is available through the distribution network. When a grid failure occurs, the grid connection is separated from the emergency power output and power modules 12 that had been running in mains interactive mode are re-started in stand-alone mode with the neutral conductor of the emergency power output electrically grounded.

After power modules 12 change to stand-alone mode, they supply power load 28 until battery 32 becomes fully discharged. In this mode, the battery discharge may be limited to 90 VDC to protect battery 32 against deep discharge. If the solar panel array 14-18 collects PV energy during this mode, the power is sent to the power modules 12 and load 28. If the solar panel array 14-18 collects PV energy in excess of that demanded by load 28 during this mode, the excess energy is sent to battery 32. When power is restored to the distribution grid, the power station automatically returns to utility-interactive mode.

The presently disclosed invention includes other embodiments that will be apparent to those skilled in the art and are included in the scope of the following claims.

We claim:

1. A power station that selectively transfers electrical power among a photovoltaic source, an electrical load, an electric power distribution network, and a storage battery in accordance with the power level generated by the photovoltaic source relative to the power level required by the electrical load and the charge level of the storage battery, said power station comprising:
at least one power module that includes at least one inverter that is in electrical communication with the photovoltaic source and the storage battery, said inverter converting direct current to alternating current and also converting alternating current to direct current;
a battery monitoring system that is in electrical communication with said storage battery, said battery monitoring system monitoring the electrical charge level of said storage battery;
a transfer switch having a first set of terminals that are electrically connected to said electrical load and a second set of terminals that are electrically connected to said electric power distribution network, said transfer switch switching to said first set of terminals and said second set of terminals; and
a programmable controller that is in electrical communication with said at least one inverter of said power module to cause said at least one inverter to provide instantaneous, synchronized power to the second set of terminals of said power station, said programmable controller also being in electrical communication with said battery monitoring system, said programmable controller being responsive to the level of electrical charge in said storage battery, said programmable controller sending command signals to said transfer switch cause said transfer switch to selectively complete an electrical connection between said power module and said first set of terminals of said transfer switch and between said power module and said second set of terminals in accordance with the electrical charge level of said storage battery, and in accordance with the level of electric power generated by said photovoltaic source relative to the power demand of said load.

2. The power station of claim 1 wherein electrical power produced from said power module in excess of said power demand of said load is conveyed to said storage battery at times at times when said distribution network maintains an electric voltage and when the energy stored in said battery is greater than a predetermined minimum level and less than a predetermined threshold level that is greater than said predetermined minimum level.

3. The power station of claim 1 wherein electrical power demanded by said load in excess of said electrical power generated by said photovoltaic source is drawn from said battery at times when said distribution network maintains an electrical voltage and when the energy stored in said battery is greater than said predetermined threshold level.

4. The power station of claim 1 wherein said power module provides instantaneous electrical power to said load in the amount of power demand of said load and wherein said power module conducts instantaneous power that is in excess of the power demand of said load to said distribution network at times when said storage battery is charged to full nominal capacity and said transfer switch is connected to said distribution network.

5. The power station of claim 1 wherein said programmable controller causes said power module to conduct power from said battery to said load during peaks of load power demand.

6. The power station of claim 1 wherein said programmable controller causes said power module to supply all said power demanded by said load from said storage battery at times when said photovoltaic source provides no electric power and the energy stored in said battery is greater than said threshold level.

7. The power station of claim 1 wherein said programmable controller causes all of said power demand of said load to be drawn from said distribution grid at times when said distribution network maintains an electric voltage and the electrical energy stored in said battery is less than said predetermined minimum threshold and said power module receives no electrical power from said photovoltaic source.

8. The power station of claim 1 wherein said programmable controller causes said transfer switch to disconnect from the distribution network such that power to said load is supplied by said at least one power module in combination with said storage battery at times when said distribution network does not maintain an electric voltage and the energy stored in said storage battery is greater than said predetermined minimum level.

9. The power station of claim 1 wherein said power from said power module in excess of the power demand of said load is supplied to said storage battery.

10. The power station of claim 8 wherein said programmable controller causes said transfer switch to connect to the distribution network at times when said distribution network maintains electrical voltage.

11. A power station that includes a power module, a load terminal, and an electrical distribution network terminal, said power station receiving power from a photovoltaic source and selectively making electrical connections among said power module, said load terminal and said electrical distribution network according to the charge level of said storage battery, electric power available from said photovoltaic source and electrical power demands of said load, said power station comprising:
a power module that receives electrical power from at least one photovoltaic source, said power module including at least two inverters for converting between direct current and alternating current;
a storage battery that is connected to said power module, said storage battery storing energy at times when power from said at least two inverters exceeds the demand of said electrical load;
a battery monitoring system that monitors electrical conditions of said storage battery;
a grid sensor that monitors two electrical phases of said electrical distribution network for metering voltage, current and energy flow, said grid sensor also initiating backup emergency power mode for the power station and metering power for synchronizing said at least two inverters to instantaneously match load demand; and
a programmable controller that is in electrical communication with said power module, said battery monitoring system, and said grid sensor, said programmable controller synchronizing the electrical output of said at least two inverters of said power module to provide instantaneous power to match the power demand of said load.

12. The power station of claim 11 wherein, at times when the charge level of said battery is greater than a selected minimum level but less than a selected threshold level that is greater than said minimum level, said programmable controller causes said power station to supply energy to the storage battery at times when the energy demand at said load terminal is less than the power generated by said photovoltaic source.

13. The power station of claim 11 wherein, at times when the charge level of said battery is greater than a selected minimum level, but less than a threshold level that is greater than the minimum level, said programmable controller causing said power station to supply energy to said storage battery when power generated by said photovoltaic source is greater than the power demand of said load, and also causes said power station to draw energy from the distribution network when the power generated by said photovoltaic source is less than the power demand of said load.

14. The power station of claim 12 wherein, when power generated by said photovoltaic source exceeds the demand at said load terminal, the excess energy is stored in said battery.

15. The power station of claim 12 wherein, at times when the charge level of said battery is greater than a maximum level that is greater than said threshold level, said power station supplies power to the distribution network terminal at times when the power generated by the photovoltaic source is greater than the load demand and draws energy from the battery at times when the power generated by the photovoltaic source is less than the load demand.

16. The power station of claim 11 wherein, at times when the charge level of said storage battery is less than said minimum level of the battery, said power station supplies power only to said storage battery.

17. The power station of claim 11 wherein, at times when the instantaneous energy of said load demand is greater than the power generated by the photovoltaic source, said power module draws DC power from said battery and supplies AC power to said load.

18. The power station of claim 11 wherein, at times when there is no power generated by the photovoltaic source and the charge level of said battery is greater than said minimum threshold level, the power station draws energy only from said battery and supplies that energy to said load.

19. The power station of claim 11 wherein said inverters of said power module provide instantaneous, synchronized power at times when power is unavailable from said distribution network.

20. The power station of claim 11 further comprising an emergency power by-pass contactor that connects said load to said inverter at times when electrical power is unavailable from said electrical distribution network.
